(19) United States
(12) Patent Application Publication
(10) Pub. No.: US 2006/0266858 A1
(43) Pub. Date: Nov. 30, 2006

(54) Food processing equipment

(76) Inventor: Hong-Bae Kim, Gyeonggi-do (KR)

Correspondence Address: ST. ONGE STEWARD JOHNSTON & REENS, LLC, 986 BEDFORD STREET, STAMFORD, CT, 06905-5619, US

(21) Appl. No.: 11/441,938

(22) Filed: May 26, 2006

(30) Foreign Application Priority Data
May 27, 2005 (KR) 20-2005-0015138

(51) Int. Cl. B02C 19/00

(52) U.S. Cl. 241/199.12

(57) ABSTRACT

A food processing apparatus includes a vessel having an internal space for containing food material therein. A body is seated on a top portion of the vessel, and has a seating part formed in a periphery with a plurality of coupling holes. A body cover is coupled with the top surface of the seating part, and can be opened and closed. A silicone packing is disposed between the body cover and the body, and has protrusions extending from a bottom surface thereof in positions corresponding to the coupling holes of the seating part. Each of the protrusions has a recess formed therein, thereby to be easily deformed when inserted into each of the coupling holes. The silicone packing disposed between the body and the body cover can stably maintain coupling while preventing steam from entering through a gap in a joint between the body and the body cover.

### BACKGROUND OF THE INVENTION

1. Field of the Invention

The present invention relates to a food processing apparatus, and more particularly to a food processing apparatus which has a silicone packing disposed between a body and a body cover to stably maintain coupling between the body and the body cover as well as to prevent steam from entering through a gap in a joint between the body and the body cover, thereby protecting electronics inside the food processing apparatus.

2. Description of the Prior Art

Recently, thanks to the importance and merits attributed to beans, the public has been showing more interest in bean foods such as bean curd and bean oil.

Accordingly, various types of food processing apparatuses have been introduced to more easily produce bean curd or bean oil which was difficult and time-consuming conventionally.

Such a food processing apparatus adopts a silicone packing, which is harmless to men, in order to create a seal between a vessel and a body. A technology for sealing the vessel and the body using such a silicone packing was proposed in Korean Registered Utility Model No. 338530 (registered Jan. 5, 2004) in the title of “Silicone Packing Coupling Device of Home Bean-Curd Producer”, filed by the assignee of this application.

As shown in FIG. 1, such a conventional food processing apparatus includes a vessel 1 having a hollow space therein, a body cover 3 mounted on a top portion of the vessel 1, capable of being opened and closed, a body 7 attached to the bottom of the body cover 3. The body 7 is internally mounted with an electronic device such as a motor (not shown) for generating rotational power. The food processing apparatus also includes a silicone packing 5 attached to the bottom edge of the body cover 3.

However, the conventional food processing apparatus has a drawback in that the silicone packing is located between the top surface of the vessel 1 and the bottom edge of the body cover 3, which allows steam generated from heated water to enter through a gap between the body 7 and the body cover 3, thereby causing electric short-circuit to or sticking within the electronic device such as a motor installed inside the body 7.

### SUMMARY OF THE INVENTION

Accordingly, the present invention has been made to solve the above-mentioned problems occurring in the prior art, and an object of the present invention is to provide a food processing apparatus, which has a silicone packing disposed between a body and a body cover to stably maintain coupling between the body and the body cover as well as to prevent steam from entering through a gap in a joint between the body and the body cover, thereby protecting electronics inside the food processing apparatus.

According to an aspect for accomplishing the foregoing object, there is provided a food processing apparatus comprising: a vessel having an internal space for containing food material therein; a body seated on a top portion of the vessel, the body having a seating part formed in a periphery with a plurality of coupling holes formed along a top surface of the seating part; a body cover coupled with the top surface of the seating part in a fashion capable of being opened and closed; and a silicone packing disposed between the body cover and the body, the packing having protrusions extending from a bottom surface thereof in positions corresponding to the coupling holes of the seating part, wherein each of the protrusions has a recess formed therein, thereby to be easily deformed when inserted into each of the coupling holes, whereby insertion is performed easily.

According to another aspect for accomplishing the foregoing object, there is provided a food processing apparatus comprising: a vessel having an internal space for containing food material therein; a body seated on a top portion of the vessel, the body having a seating part formed in a periphery and a plurality of coupling recesses formed along a top surface of the seating part; a body cover coupled with the top surface of the seating part in a fashion capable of being opened and closed; and a silicone packing disposed between the body cover and the body, the packing having protrusions extending from a bottom surface thereof in positions corresponding to the coupling recesses of the seating part, wherein each of the protrusions is separated into at least two branches, thereby to be easily deformed when inserted into each of the coupling recesses, whereby insertion is performed easily.

Preferably, according to the first or second one of the afore-mentioned apparatuses of the invention, the protrusion has a tip rounded to be easily inserted into the coupling hole or recess.

According to a further another aspect for accomplishing the foregoing object, there is provided a food processing apparatus comprising: a vessel having an internal space for containing food material therein; a body having a seating part formed in a periphery to be seated on a top surface of the vessel, the seating part having a step formed along an upper outermost portion thereof; a body cover having a step coupling with the step of the body; and a silicone packing disposed inside the step of the body and the step of the body cover.

According to still another aspect for accomplishing the foregoing object, there is provided a food processing apparatus comprising: a vessel having an internal space for containing food material therein; a body having a seating part formed in a periphery to be seated on a top surface of the vessel, the seating part having an upward protrusion formed on an upper outermost portion thereof; a body cover coupling inside the upward protrusion of the body; and a silicone packing disposed between an inside surface of the upward protrusion and the body cover.

According to yet another aspect for accomplishing the foregoing object, there is provided a food processing apparatus comprising: a vessel having an internal space for containing food material therein; a body having a seating part formed in a periphery to be seated on a top surface of the vessel; a body cover coupling with the body, the body cover having a downward protrusion formed in an outermost portion thereof to surround the seating part of the body; and a silicone packing disposed between an inside surface of the downward protrusion of the body cover and the body.

Hereinafter, preferred embodiments of the present invention will be fully described with reference to the accompanying drawings in such a degree that those skilled in the art can easily carry out the invention. The foregoing and other purposes, features, operations, effects and operational benefits of the invention will be more fully understood in view of the preferred embodiments.

### BRIEF DESCRIPTION OF THE DRAWINGS

FIG. 1 is a perspective view illustrating a conventional food processing apparatus;

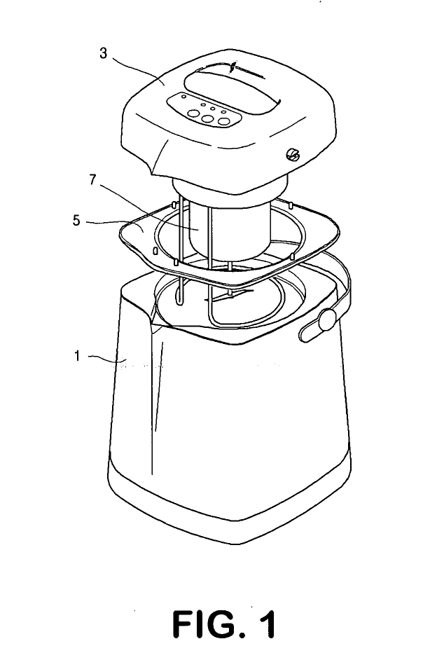

FIG. 2 is an exploded perspective view illustrating a food processing apparatus according to a first embodiment of the invention;

FIG. 3 is a perspective view illustrating a silicone packing and a body of the food processing apparatus according to the first embodiment of the invention;

FIG. 4 is an installation view illustrating the silicone packing of the food processing apparatus according to the first embodiment of the invention;

FIG. 5 is an installation view illustrating a silicone packing of a food processing apparatus according to a second embodiment of the invention;

FIG. 6 is an installation view illustrating a silicone packing of a food processing apparatus according to a third embodiment of the invention;

FIG. 7 is an installation view illustrating a silicone packing of a food processing apparatus according to a fourth embodiment of the invention;

FIG. 8 is an installation view illustrating a silicone packing of a food processing apparatus according to a fifth embodiment of the invention;

FIG. 9 is an installation view illustrating a silicone packing of a food processing apparatus according to a sixth embodiment of the invention; and

FIG. 10 is an installation view illustrating a silicone packing of a food processing apparatus according to a seventh embodiment of the invention.

### DETAILED DESCRIPTION OF THE PREFERRED EMBODIMENTS

For reference, embodiments as described herein below are merely a few of various forms in which the principles of the invention may be employed, and are selectively illustrated to give better understanding of the invention to those skilled in the art. Rather, it should be understood that various changes, additions, modifications and equivalents thereof can be made without departing from the spirit and scope of the invention.

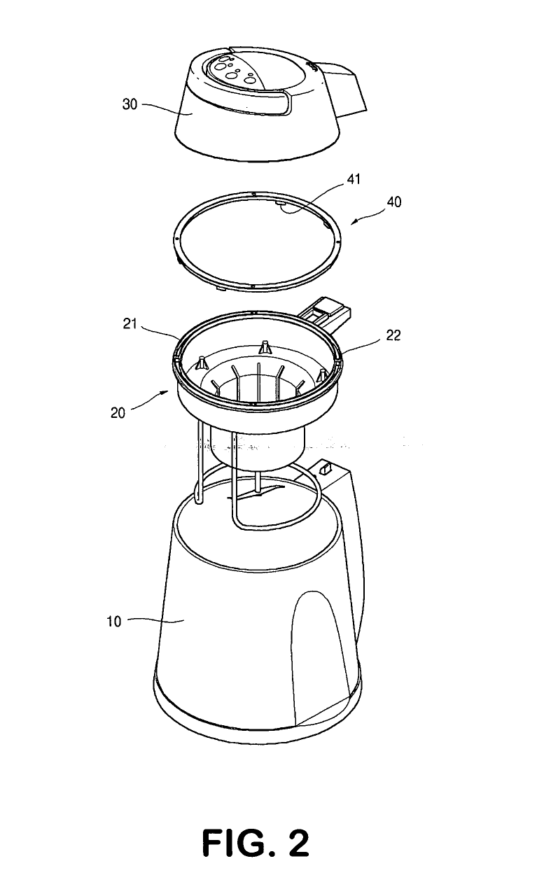

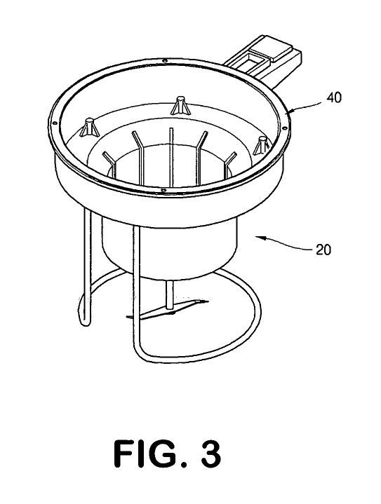

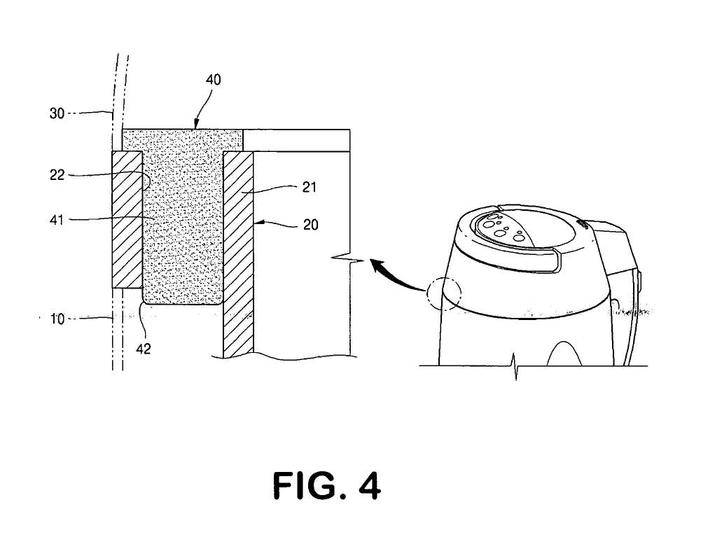

FIG. 2 is an exploded perspective view illustrating a food processing apparatus according to a first embodiment of the invention, FIG. 3 is a perspective view illustrating a silicone packing and a body of the food processing apparatus according to the first embodiment of the invention, and FIG. 4 is an installation view illustrating the silicone packing of the food processing apparatus according to the first embodiment of the invention.

As shown in FIGS. 2 to 4, the food processing apparatus according to the first embodiment of the invention includes a vessel 10 having an internal space for containing food material therein and a body 20 having a seating part 21 for allowing the body 20 to be seated on a top portion of the vessel 10. The seating part 21 has a plurality of coupling holes 22 formed along the top surface of the seating part 21. The food processing apparatus also includes a body cover 30 coupled with the top surface of the seating part 21 in a fashion capable of being opened and closed, and a silicone packing 40 disposed between the body cover 30 and the body 20. The silicone packing 40 has protrusions 41 extending from the bottom surface thereof in positions corresponding to the coupling holes 22 of the seating part 21.

Each of the protrusions 41 of the silicone packing 40 has a tip 42 rounded to be easily inserted into the coupling hole 22 of the body 20.

The food processing apparatus constructed above according to the first embodiment of the invention will operate as described below.

The silicone packing 40 is coupled with the seating part 21 of the body 20 by placing the silicone packing 40 above the seating part 21 of the body 20, and inserting the protrusions 41 of the silicone packing 40 into the coupling holes 22 perforated in the top surface of the seating part 21 of the body 20 in positions corresponding to the protrusions 41.

Then, the protrusions 41 of the silicone packing 40 are tightly coupled with the coupling holes 22 perforated in the top surface of the seating part of the body 20, and thus the silicone packing 40 and the seating part 21 are coupled with each other relatively more stably.

The body 20 coupled with the silicone packing 40 as above is seated on the top portion of the vessel 10, followed by binding the body cover 30 with the seating part 21 of the body 20 coupled with the silicone packing 40, to couple the body 20 with the body cover 30. In this fashion, the silicone packing 40 ensures stable coupling between the body 20 and the body cover 30 while preventing steam from entering through a gap between the body 20 and the body cover 30, thereby protecting an electronic device such as a motor installed inside the body 20 from electric short-circuit and the like.

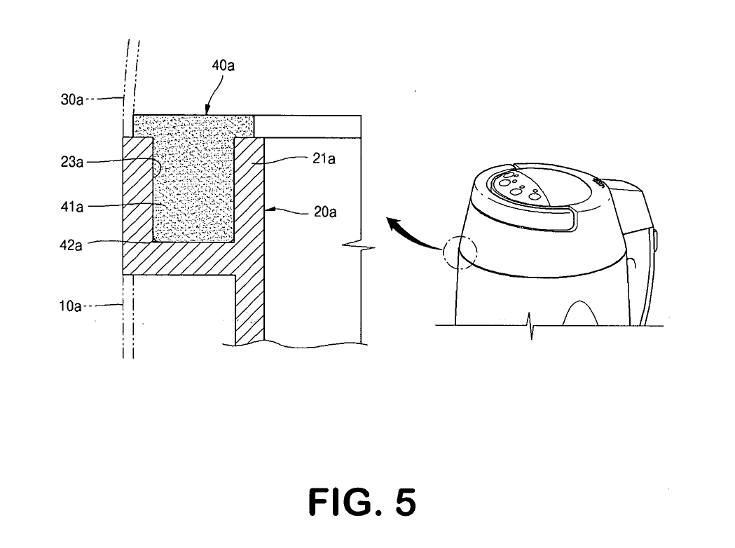

FIG. 5 is an installation view illustrating a silicone packing of a food processing apparatus according to a second embodiment of the invention.

As shown in FIG. 5, the food processing apparatus according to the second embodiment of the invention includes a vessel 10a having an internal space for containing food material therein and a body 20a having a seating part 21a for allowing the body 20 to be seated on a top portion of the vessel 10a. The food processing apparatus also includes a plurality of coupling recesses 23a formed along the top surface of the seating part 21a, a body cover 30a coupled with the top surface of the seating part 21a in a fashion capable of being opened and closed, and a silicone packing 40a disposed between the body cover 30a and the body 20a. The silicone packing 40a has protrusions 41a extending from the bottom surface thereof in positions corresponding to the coupling recesses 23a of the seating part 21a.

Each of the protrusions 41a of the silicone packing 40a has a tip 42a rounded to be easily inserted into the coupling recesses 23a.

The food processing apparatus constructed as above according to the second embodiment of the invention has substantially the same configuration as that according to the first embodiment except that the coupling recesses 23a are formed in place of the coupling holes 22.

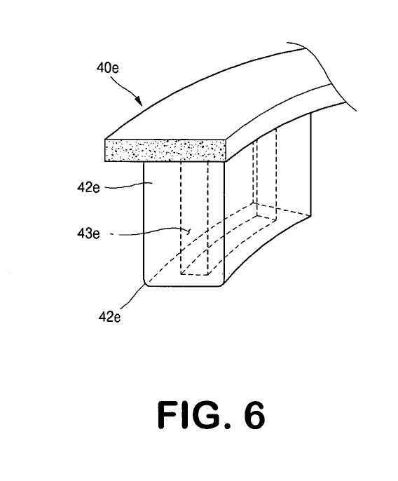

FIG. 6 is an installation view illustrating a silicone packing of a food processing apparatus according to a third embodiment of the invention.

As shown in FIG. 6, the food processing apparatus according to the third embodiment of the invention has substantially the same configuration and effects as those according to the first or second embodiment except that a hole 43e is formed in a protrusion 41e of a silicone packing 40e to facilitate deformation of the protrusion 41e in case of insertion into a coupling hole or recess (see the reference sign 22 in FIG. 4 or 23a in FIG. 5), such that insertion can be performed easily.

The protrusion 41e of the silicone packing 40e has a tip 42e rounded to be easily inserted into the coupling hole or recess.

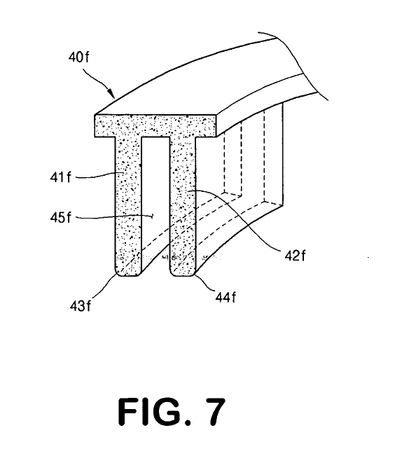

FIG. 7 is an installation view illustrating a silicone packing of a food processing apparatus according to a fourth embodiment of the invention.

As shown in FIG. 7, the food processing apparatus according to the fourth embodiment of the invention has substantially the same configuration and effects as those according to the first or second embodiment except that protrusions 41f and 42f of a silicone packing 40f are separated into branches from each other with a space 45f formed between the protrusions 41f and 42f. This configuration facilitates deformation of the protrusion 41f or 42f in case of insertion into a coupling hole or recess (see the reference sign 22 in FIG. 4 or 23a in FIG. 5) so that insertion can be carried out easily.

Each of the protrusions 41f and 42f of the silicone packing 40f has a tip 43f or 44f rounded to be easily inserted into the coupling hole or recess.

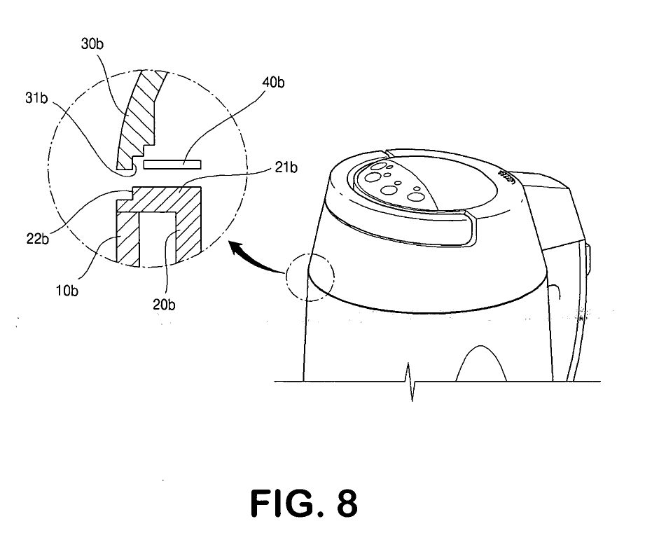

FIG. 8 is an installation view illustrating a silicone packing of a food processing apparatus according to a fifth embodiment of the invention.

As shown in FIG. 8, the food processing apparatus according to the fifth embodiment of the invention includes a vessel 10b having an internal space for containing food material therein, a body 20b having a seating part 21b for allowing the body 20b to be seated on a top portion of the vessel 10b with a step 22b formed along the upper outermost portion of the seating part 21b, a body cover 30b having a step 31b coupling with the step 22b of the body 20b, and a silicone packing 40b disposed inside the step 22b of the body 20b and the step 31b of the body cover 30b.

The food processing apparatus constructed above according to the fifth embodiment of the invention will operate as described below.

After the silicone packing 40b is placed inside between the step 22b of the body 20b and the step 31b of the body cover 30b, the body 20b and the body cover 30b are coupled with each other so that the silicone packing 40b is bound together.

Then, the step 22b of the body 20b is tightly bound with the step 31b of the body cover 30b with the silicone packing 40b coupled therein to impart double-sealing to the space between the body 20b and the body cover 30b. This as a result can prevent steam from entering through a gap between the body 20b and the body cover 30b thereby protecting an electronic device such as a motor installed inside the body 20b from electric short-circuit and the like.

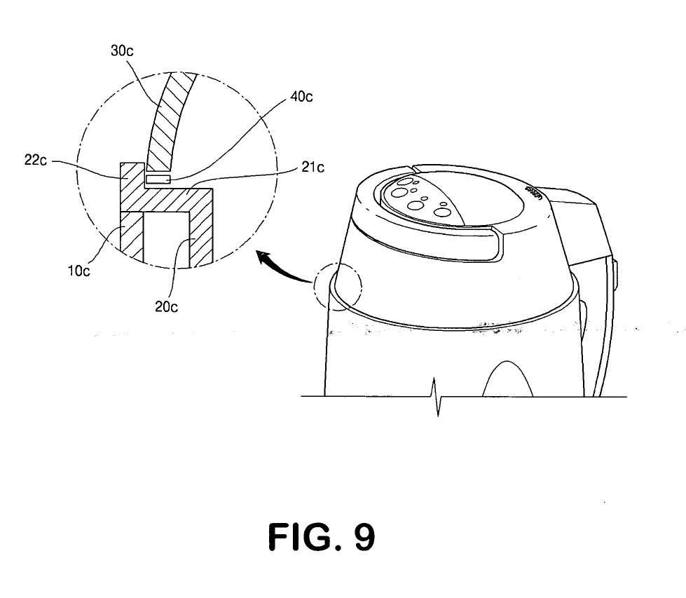

FIG. 9 is an installation view illustrating a silicone packing of a food processing apparatus according to a sixth embodiment of the invention.

As shown in FIG. 9, the food processing apparatus according to the sixth embodiment of the invention includes a vessel 10c having an internal space for containing food material therein and a body 20c having a seating part 21c formed at a periphery thereof for seating the body 20c on a top portion of the vessel 10c. The body 20c has a protrusion 22c extending from the upper outermost portion of the seating part 21c. The food processing apparatus also includes a body cover 30c coupling inside the upward protrusion 22c of the body 20c and a silicone packing 40c disposed between the inside surface of the upward protrusion 22c of the body 20c and the body cover 30c.

The food processing apparatus constructed above according to the sixth embodiment of the invention will operate as described below.

After the silicone packing 40c is placed inside the upward protrusion 22c of the body 20c and the body cover 30c is seated on the silicone packing 40cthe body 20c and the body cover 30c are coupled with each other so that the silicone packing 40c is bound together.

In this case, the upward protrusion 22c of the body 20c is tightly bound with the body cover 30c with the silicone packing 40c coupled therein to impart double sealing to the space between the body 20c and the body cover 30c. This as a result can prevent steam from entering through a gap between the body 20c and the body cover 30c thereby protecting an electronic device such as a motor installed inside the body 20c from electric short-circuit and the like.

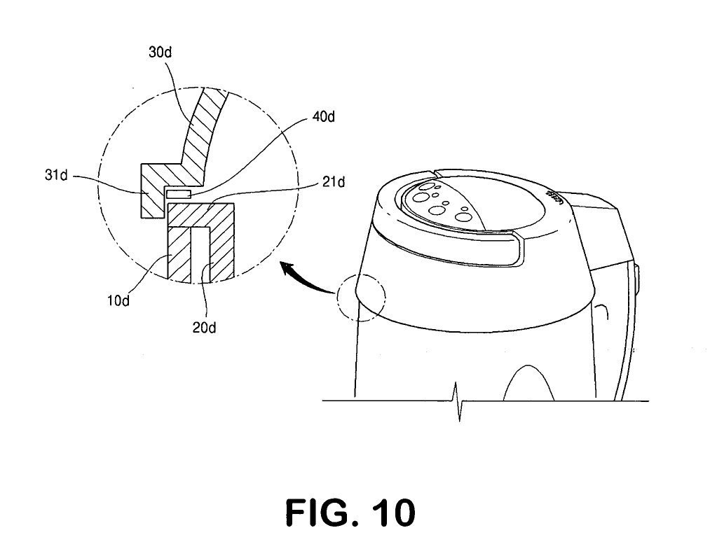

FIG. 10 is an installation view illustrating a silicone packing of a food processing apparatus according to a seventh embodiment of the invention.

As shown in FIG. 10, the food processing apparatus according to the seventh embodiment of the invention includes a vessel 10d having an internal space for containing food material therein, a body 20d having a seating part 21d formed at a periphery thereof for seating the body 20d on a top portion of the vessel 10d and a body cover 30d coupling with the body 20d. The body cover 30d has a downward protrusion 31d formed in an outermost portion thereof to surround the seating part 21d of the body 20d. The food processing apparatus also includes a silicone packing 40d disposed between the inside surface of the downward protrusion 31d of the body cover 30d and the body 20d.

The food processing apparatus constructed above according to the seventh embodiment of the invention will operate as described below.

After the silicone packing 40d is placed above the seating part 21d of the body 20c the body 20d and the body cover 30d are coupled with each other with the downward protrusion 31d covering the seating part 21d of the body 20d so that the silicone packing 40d is bound together between the inside surface of the downward protrusion 31d and the body 20d.

In this case, the downward protrusion 31d of the body cover 30d is tightly bound with the seating part 21d of the body 20d with the silicone packing 40d bound between the inside surface of the downward protrusion 31d and the body 20d to impart double-sealing to the space between the body 20d and the body cover 30d. This as a result can prevent steam from entering through a gap between the body 20d and the body cover 30d, thereby protecting an electronic device such as a motor installed inside the body 20d from electric short-circuit and the like.

As set forth above, the food processing apparatus according to certain embodiments of the invention has a silicone packing disposed between a body and a body cover to stably maintain coupling between the body and the body cover as well as to prevent steam from entering through a gap in a joint between the body and the body cover, thereby protecting electronics inside the food processing apparatus.

1. A food processing apparatus comprising:
a vessel having an internal space for containing food material therein;
a body seated on a top portion of the vessel, the body having a seating part formed in a periphery with a plurality of coupling holes formed along a top surface of the seating part;
a body cover coupled with the top surface of the seating part in a fashion capable of being opened and closed; and
a silicone packing disposed between the body cover and the body, the packing having protrusions extending from a bottom surface thereof in positions corresponding to the coupling holes of the seating part,
wherein each of the protrusions has a recess formed therein, thereby to be easily deformed when inserted into each of the coupling holes, whereby insertion is performed easily.

2. A food processing apparatus comprising:
a vessel having an internal space for containing food material therein;
a body seated on a top portion of the vessel, the body having a seating part formed in a periphery and a plurality of coupling recesses formed along a top surface of the seating part;
a body cover coupled with the top surface of the seating part in a fashion capable of being opened and closed; and
a silicone packing disposed between the body cover and the body, the packing having protrusions extending from a bottom surface thereof in positions corresponding to the coupling recesses of the seating part,
wherein each of the protrusions is separated into at least two branches, thereby to be easily deformed when inserted into each of the coupling recesses, whereby insertion is performed easily.

3. The food processing apparatus according to claim 1, wherein the protrusion has a tip rounded to be easily inserted into the coupling hole or recess.

4. A food processing apparatus comprising:
a vessel having an internal space for containing food material therein;
a body having a seating part formed in a periphery to be seated on a top surface of the vessel, the seating part having a step formed along an upper outermost portion thereof;
a body cover having a step coupling with the step of the body; and
a silicone packing disposed inside the step of the body and the step of the body cover.

5. A food processing apparatus comprising:
a vessel having an internal space for containing food material therein;
a body having a seating part formed in a periphery to be seated on a top surface of the vessel, the seating part having an upward protrusion formed on an upper outermost portion thereof;
a body cover coupling inside the upward protrusion of the body; and
a silicone packing disposed between an inside surface of the upward protrusion and the body cover.

6. A food processing apparatus comprising:
a vessel having an internal space for containing food material therein;
a body having a seating part formed in a periphery to be seated on a top surface of the vessel;
a body cover coupling with the body, the body cover having a downward protrusion formed in an outermost portion thereof to surround the seating part of the body; and a silicone packing disposed between an inside surface of the downward protrusion of the body cover and the body.

7. The food processing apparatus according to claim 2, wherein the protrusion has a tip rounded to be easily inserted into the coupling hole or recess.
